(19) United States
(12) Patent Application Publication
(10) Pub. No.: US 2022/0295707 A1
(43) Pub. Date: Sep. 22, 2022

(54) Improved Crop Harvesting Apparatus

(71) Applicant: WILLIAMES TEA PTY LTD, Warragul, Victoria (AU)

(72) Inventor: Geoffrey Alan Williames, Warragul, Victoria (AU)

(21) Appl. No.: 17/633,814

(22) PCT Filed: Aug. 7, 2020
(86) PCT No.: PCT/AU2020/050823

§ 371 Date: Feb. 8, 2022

(30) Foreign Application Priority Data
Aug. 9, 2019 (AU) 2019902874

(51) Int. Cl. A01D 46/04

(52) U.S. Cl. CPC A01D 46/04; A01D 34/44

(57) ABSTRACT

An apparatus for selectively harvesting a plant material (such as tea plants) having a stem. The apparatus has a first plant material engaging element rotatable about a first axis, and a second plant material engaging element rotatable about a second axis in the opposite direction to, and synchronized at a fixed ratio with, rotation of the first engaging element. The first and second engaging elements each have a moveable engagement surface to entrap a first respective upper portion of a plant stem therebetween. With continued rotation, the first and second engaging elements pull the entrapped first respective upper portion of the plant over a time period so as cause increasing tension in a second respective lower portion of the plant stem. The second engaging element has a plant material breaking surface which is moveable along an arc so as to contact the second respective lower portion of the plant stem.

### FIELD OF THE INVENTION

The present invention relates generally to apparatus for selectively harvesting material from crop plants, including but not limited to tea plants (Camellia sinensis).

### BACKGROUND TO THE INVENTION

Tea is undoubtedly a crop of global economic significance. In 2017, the global tea market was estimated at around US$50 Billion, with the largest producers being China, India, Sri Lanka, and Kenya.

Since 2,733 BC when Chinese Emperor Shen-Nune brewed tea, and for the 4,392 years following, tea has been manually selectively plucked. To produce exquisite high value tea requires the careful selection and plucking of two leaves and a bud without harvesting any of the surrounding extraneous dark maintenance foliage or the juvenile next generation shoots.

Reference is made to FIG. 1 showing plucked tea plant material comprising the desired two leaves (3) and a bud (1) extending from a stem (5). The broken lower terminus of the plant material results from hand-plucking at the desired plucking point (6).

The plucked plant material of FIG. 1 is shown in FIG. 2 in its original context on the tea plant (i.e. before plucking). Superimposed on FIG. 2 are three levels: A above which the bud (2) is disposed; B above which the bud (2) and desirable leaves (3), (4) are disposed; and C above which the bud (2), desirable leaves (3), (4) and low quality mature leaves (7), (8), (9) are disposed. As will be noted, plucking at level A will leave behind the desirable leaves (3), (4); and plucking at level C will keep the bud (2) and desirable leaves (3), (4) but also keep the low quality leaves (7), (8), (9). Only by plucking at level B will selective harvesting of the bud (2) and desirable leaves (3), (4) be achieved.

Reference is made to FIG. 3 showing the-well established prior art method of selective harvesting two desirable leaves (not visible) and a bud (1) by clamping the two leaves and a bud stem (5) between the thumb (10) and forefinger (11), and rotating the hand (12) in the direction of arrow (13).

The severing of the bud and two desirable leaves is shown sequentially in FIG. 4 and FIG. 5. FIG. 4 is an alternative view of FIG. 3 (i.e. before severance of the bud and two desirable leaves). FIG. 5 shows the plucking action by maintaining the clamping pressure of the thumb (10) and forefinger (11) and rotating the hand (12) at the wrist (16) in the direction of arrow (13) and with the stem (5) wrapped around the relatively small diameter forefinger (11) thereby inducing a force along the vector (17) causing the bud stem (5) to snap at (18) so as to selectively pluck the intact undamaged two desirable leaves and a bud (1).

As will be appreciated from FIGS. 3, 4, 5 and the associated description above there is some complication in firstly identifying the correct region to grasp the stem, secondly in applying the fingers so as to ensure that a bud and two desirable leaves in superior to the grasped region, and thirdly that undesirable leaves and stem parts are not included in the portion to be plucked. Whilst workers very experienced in tea plucking are able to rapidly visually assess a plant and pluck only the desired components, harvesting tea is still a laborious, time intensive and expensive process for the producer. Given the significant level of manual labour, time and cost to harvest a tea crop manually, a number of prior artisans have attempted to construct automated harvesters.

Some prior art harvesters require a cutter or a breaker disposed in front of a leading edge of a conveyor belt to sever the upper portions of the plant. While generally operable, such arrangements may provide an inferior result to hand picking by causing some collateral damage to maintenance foliage and juvenile shoots, or the harvesting of undesired structures such as mature leaves.

Accordingly, there still exists a need in the art for an apparatus that more closely mimics the ability of the human hand to judiciously remove only the bud and two desirable leaves from a tea plant, whilst also minimising damage to remaining plant structures.

It is an aspect of the present invention to provide an improvement in apparatus for harvesting plant material. It is a further aspect of the present invention to provide a useful alternative to prior art harvesting apparatus.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

In a first aspect, the present invention provides an apparatus for selectively harvesting a plant material comprising a stem, the apparatus comprising: a first plant material engaging means being rotatable about a first axis, a second plant material engaging means being rotatable about a second axis in the opposite direction to, and synchronized at a fixed ratio with, the rotation of the first plant material engaging means, the first and second plant material engaging means each having a moveable plant material engagement surface configured to entrap a first respective upper portion of a plant stem therebetween and with continued rotation of the first and second plant material engaging means pull the entrapped first respective upper portion of the plant over a time period so as cause increasing tension in a second respective lower portion of the plant stem, the second plant material engaging means comprising a plant material breaking surface which is moveable along an arc so as to contact the second respective lower portion of the plant stem, wherein the plant material breaking surface is shaped so as to form a bend in the second respective lower portion of the plant stem as it is moved along the arc, and with the increasing tension in the second respective lower portion of the plant stem cause breakage of the second respective lower portion of the plant stem over the plant material breaking surface.

In one embodiment of this first aspect of the invention, the synchronization at a fixed ratio provides that for each single rotation of the first plant material engagement means, the second plant material engagement means rotates at least 2, 3, 4, 5, 6 or more times.

In one embodiment of this first aspect of the invention, the first axis is above the second axis. The first axis may be offset from a vertical axis extending through the second axis, and may be offset toward the side of the apparatus from which plant material is drawn.

In one embodiment of this first aspect of the invention, the plant material breaking surface is shaped so as to form a bend of at least about 90 degrees in the respective second lower portion of the plant stem.

In one embodiment of this first aspect of the invention, the plant material breaking surface comprises a curve or a corner configured to form a bend in the respective lower portion of the plant stem.

In one embodiment of this first aspect of the invention, the plant material engagement surface of the second plant material engagement means is deformable.

In one embodiment of this first aspect of the invention, the first and second plant material engagement means are maintained in spaced relation such that the plant material engagement surface of the first plant material engagement means is capable of deforming the deformable surface of the second plant material engagement means.

In one embodiment of this first aspect of the invention, the apparatus is configured such that the plant material engagement surface of the first plant material engagement means is capable of alternately deforming and releasing the deformable surface of the second plant material engagement means.

In one embodiment of this first aspect of the invention, the plant material engagement surface of the second plant material engagement means is resilient such that upon release it assumes a non-deformed state.

In one embodiment of this first aspect of the invention, the plant material engagement surface of the second plant engagement means is a resilient belt suspended between two belt mounts so as to be deformable in the region between the two belt mounts.

In one embodiment of this first aspect of the invention, the plant material breaking surface is non-deformable or of limited deformability so as to facilitate breakage of plant material there over.

In one embodiment of this first aspect of the invention, the second plant material engaging means comprises a plant material contacting surface moveable along an arc and configured to contact the plant stem at a third respective portion of the plant stem that is lower than the second portion of the plant stem, wherein the plant material contacting surface is configured to assist in effecting the increasing tension in the respective second lower portion of the plant stem.

In one embodiment of this first aspect of the invention, the arc along which the plant material contacting surface is moveable is the same arc as the arc along which the plant material breaker surface is moveable.

In one embodiment of this first aspect of the invention, the second plant engagement means comprises a rotor having at least sequential first, second and third arms.

In one embodiment of this first aspect of the invention, the plant material engagement surface of the second plant engagement means comprises a resilient belt, the resilient belt is suspended between sequential first and second arms and the sequential third arm supports the plant material contacting surface.

In one embodiment of this first aspect of the invention, the breaking surface is supported by the respective second arm.

In one embodiment of this first aspect of the invention, the first and third sequential arms are disposed along a first axis.

In one embodiment of this first aspect of the invention, the second sequential arm is disposed along a second axis that is substantially orthogonal to the first axis.

In one embodiment of this first aspect of the invention, the first sequential arm forms an angle of about 90 degrees with the second sequential arm.

In one embodiment of this first aspect of the invention, the second sequential arm forms an angle of about 90 degrees with the third sequential arm.

In one embodiment of this first aspect of the invention, the apparatus comprises a fourth sequential arm disposed along the second axis.

In one embodiment of this first aspect of the invention, the fourth sequential arm supports a further plant contacting surface.

In one embodiment of this first aspect of the invention, the space between the second and third sequential arms is substantially open such that plant material is able to enter and exit the space.

In one embodiment of this first aspect of the invention, the space between the third and fourth arms is substantially open such that plant material is able to enter and exit the space.

In one embodiment of this first aspect of the invention, the space between the first and fourth arms is substantially open such that plant material is able to enter and exit the space.

In one embodiment of this first aspect of the invention, the plant material engagement surface of the first plant material engagement means is configured to alternately contact and release from the plant material engagement surface of the second plant material engagement means.

In one embodiment of this first aspect of the invention, the first plant engagement means comprises a rotor having at least sequential first, second and third arms.

In one embodiment of this first aspect of the invention, at least one of the at least first, second and third sequential arms supports the plant material engagement surface.

In one embodiment of this first aspect of the invention, the apparatus comprises first, second and third plant material engagement surfaces supported respectively by the first, second and third sequential arms.

In one embodiment of this first aspect of the invention, the first and third sequential arms are disposed along a first axis.

In one embodiment of this first aspect of the invention, the second sequential arm is disposed along a second axis that is substantially orthogonal to the first axis.

In one embodiment of this first aspect of the invention, the first sequential arm forms an angle of about 90 degrees with the second sequential arm.

In one embodiment of this first aspect of the invention, the second sequential arm forms an angle of about 90 degrees with the third sequential arm.

In one embodiment of this first aspect of the invention, the apparatus comprises a fourth sequential arm disposed along the second axis.

In one embodiment of this first aspect of the invention, the space between the first and second sequential arms is substantially open such that plant material is able to enter and exit the space.

In one embodiment of this first aspect of the invention, the space between the second and third sequential arms is substantially open such that plant material is able to enter and exit the space.

In one embodiment of this first aspect of the invention, the space between the third and fourth sequential arms is substantially open such that plant material is able to enter and exit the space.

In one embodiment of this first aspect of the invention, the space between the first and fourth sequential arms is substantially open such that plant material is able to enter and exit the space.

In one embodiment of this first aspect of the invention, the first and second plant material engagement means are respectively a first rotor and a second rotor, each of the first and second rotors having evenly spaced arms extending radially from a central portion, the first and second rotators in relative spatial arrangement.

In one embodiment of this first aspect of the invention, the plant material engagement surface of the first plant material engagement means is a roller disposed at the terminus of a rotor arm.

In one embodiment of this first aspect of the invention, the diameter of the first rotor is at least about 1, 1.5, 2, 2.5, 3 or more times that of the second rotor.

In one embodiment of this first aspect of the invention, the apparatus comprises plant material carriage means configured to carry free plant material broken from the plant away from the first and second plant material engagement means.

In one embodiment of this first aspect of the invention, the plant material carriage means functions so as to sweep free plant material by way of an air current or by contact with a moving member.

In one embodiment of this first aspect of the invention, the plant material carriage means rotates about an axis.

In one embodiment of this first aspect of the invention, the plant material carriage means is a rotating brush or a rotor.

In one embodiment of this first aspect of the invention, the apparatus comprises means for moving the plant material engagement surfaces of the first and/or second plant material engagement means.

In one embodiment of this first aspect of the invention, the apparatus is configured to be maintained at a height in relation to a crop of plants to be harvested such that the uppermost portions of the plants are drawn between the first and second plant engagement means.

In one embodiment of this first aspect of the invention, the apparatus comprises one or more handles adapted to be held by one or more users and maintain the apparatus at the height.

In one embodiment of this first aspect of the invention, the apparatus comprises supports adapted to rest on the ground or a vehicle to maintain the apparatus at the height.

In one embodiment of this first aspect of the invention, the apparatus comprises means for propelling the apparatus forward and across a crop of plants.

The invention may be defined by way of further features of this first aspect, or a second aspect or even further aspects as will be apparent from a consideration of the remainder of this description.

### BRIEF DESCRIPTION OF THE FIGURES

FIG. 1 illustrates a terminal portion of a tea plant for harvest, comprising the highly desired two leaves and a bud.

FIG. 2 illustrates three levels (shown as dashed lines, A, B and C) at which a terminal portion of a tea plant may be severed, having reference to desired and undesired structures of the plant.

FIG. 3 illustrates the manual clamping action typically used by a tea plucker on a stem of a terminal portion of a tea plant.

FIG. 4 is an alternative view of the illustration of FIG. 3.

FIG. 5 illustrates the manually clamped terminal portion of the tea plant of FIG. 3 after rotation of the plucker's hand leaving a severed terminal portion.

FIGS. 6 through 10 illustrate a single harvesting apparatus of the present invention, showing the apparatus in sequential states from the time that a harvestable plant terminal portion is contacted to the time that it is severed from the plant and released.

FIG. 11 illustrates an alternative embodiment to that illustrated in FIGS. 6 through 10, and having rollers disposed at the terminus of each rotor.

FIG. 12 illustrates how the apparatuses illustrated in FIGS. 6 through 11 avoid damage to maintenance foliage and juvenile immature shoots of a tea plant. FIG. 12 further illustrates quick attachment of the resilient member by means of press over attachment button heads.

FIG. 13 illustrates a prior art harvesting apparatus for comparative purposes only.

FIG. 14A illustrates the embodiment illustrated in FIGS. 6 through 11 fitted to a light-weight tubular frame.

FIG. 14B illustrates in plan view an embodiment being a two-man mechanical apparatus of the present invention.

FIGS. 15A through 15D illustrate various views of the lightweight transmission of dual drive double sided timing belts for reverse rotation drive high ratio speed reduction and timing and other features such as support tubes, skid pan, and leaf storage bag.

FIG. 16 illustrates a further embodiment of the present apparatus attached to a light-weight frame and supported solely by the belts.

FIGS. 17 and 18 illustrate a further embodiment of the present apparatus attached to a ride-on, self-propelled machine.

FIGS. 19 and 20 illustrate another embodiment of the present apparatus attached to a self-propelled ride-on four-wheel drive platform having a four-wheel steering machine.

FIG. 21 illustrates another embodiment of the present apparatus attached to a ride-on, self-propelled multi-wheeled machine capable of spanning three rows of tea bushes.

FIG. 22 illustrates another preferred embodiment of the present apparatus attached to a very high capacity, high performance self-propelled tracked machine.

FIG. 23 illustrates the tracks providing a low-profile ground support which passes between tea bush hedge rows.

FIG. 24 illustrates the leaf bin in the very fast load discharge position.

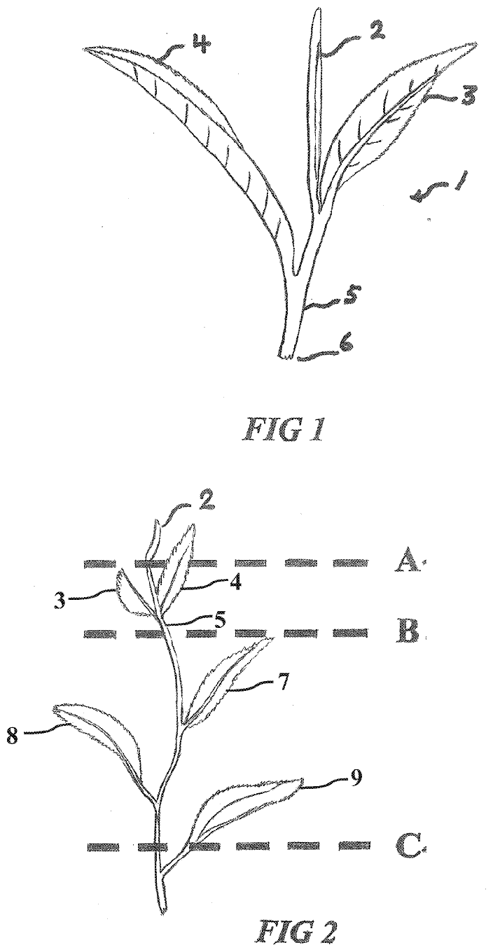

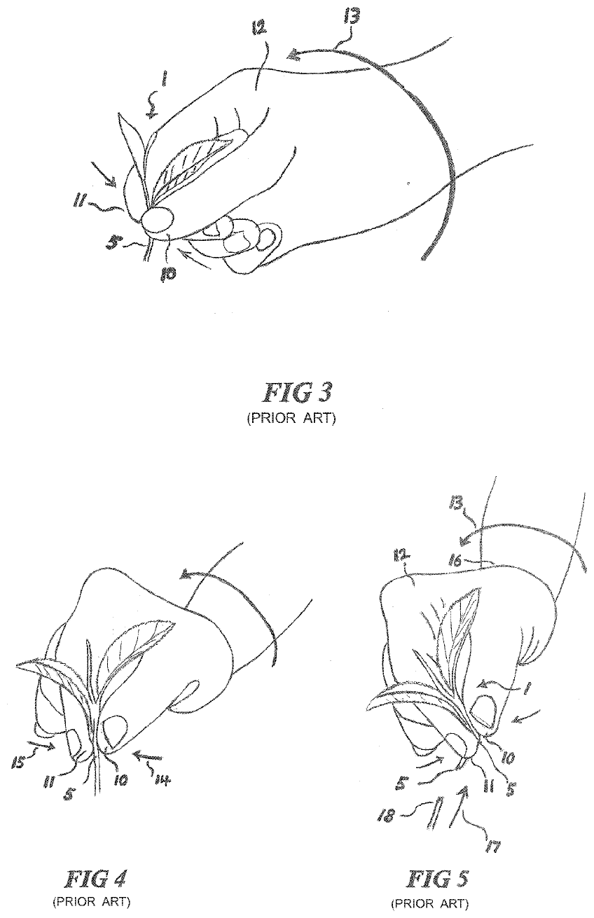

### DETAILED DESCRIPTION OF THE INVENTION

### Including Preferred Embodiments

The present invention is predicated at least in part on the inventors' discovery that the hand of a human tea plucker may be closely mimicked by an apparatus that entraps a plant stem by clamping at a certain level of the stem and then sufficiently tensions the stem across a breaker surface which is being moved upwardly and along an arc until the stem breaks. It is proposed that this clamping and rotation action mirrors the function of an experienced tea plucker's in which the fingers are used to hold the plant stem at a certain level, and the hand then generally rotates about the wrist axis such that the knuckles are rotated generally along an arc as the hand rotation progresses.

In some embodiments at least, the present apparatus is capable of selective plucking while occasioning minimal or no damage to non-harvested plant structures such juvenile shoots and maintenance foliage.

The present apparatus dispenses with the need of a breaker bar, cutter or other means for severing plant material by the use of a breaking surface over which the plant stem is tensioned, and tensioned to the point of breaking. The tension in the stem is developed by an upper portion of the plant being drawn between two plant engagement surfaces of the apparatus and because the plant is anchored into the ground at the base, tension in the stem increases over time in a lower portion of the plant as the plant is being pulled.

In a first aspect, but not necessarily the broadest aspect, the present invention provides apparatus for selectively harvesting a plant material comprising a stem, the apparatus comprising: a first plant material engaging means being rotatable about a first axis, a second plant material engaging means being rotatable about a second axis in the opposite direction to, and synchronized at a fixed ratio with, the rotation of the first plant material engaging means, the first and second plant material engaging means each having a moveable plant material engagement surface configured to entrap a first respective upper portion of a plant stem therebetween and with continued rotation of the first and second plant material engaging means pull the entrapped first respective upper portion of the plant over a time period so as cause increasing tension in a second respective lower portion of the plant stem the second plant material engaging means comprising a plant material breaking surface which is moveable along an arc so as to contact the second respective lower portion of the plant stem, wherein the plant material breaking surface is shaped so as to form a bend in the second respective lower portion of the plant stem as it is moved along the arc, and with the increasing tension in the second respective lower portion of the plant stem cause breakage of the second respective lower portion of the plant stem over the plant material breaking surface.

In one embodiment of the apparatus, rotation of the first and second plant engagement means is synchronized such that the two engagement means remain in register. The synchronization between the first and second plant engagement means is typically provided at a fixed ratio providing that for each single rotation of the first plant material engagement means, the second plant material engagement means rotates at least 2, 3, 4, 5, or 6 times. As will be appreciated, from further description infra, certain surfaces of the first and second engagement means must repeatedly contact and release thereby requiring some means of synchronizing between the two components.

The first plant engagement means may provide surfaces which rotate downwardly and the second plant engagement means which rotate upwardly and converge so as to entrap plant material therebetween. Accordingly, the rotational axis of the first plant engagement means is typically above that of the second.

In one embodiment of the apparatus, the rotational axis of the first plant engagement means is offset from a vertical axis extending through the rotational axis of the second plant engagement means. The offset may be toward the side of the apparatus from which plant material is drawn. By this arrangement, a plant material engagement surface of the first plant engagement means is able be disposed generally forward (with reference to the direction of harvesting) a plant material engagement surface of the second plant engagement means such that plant material may be laid downwardly onto an generally upwardly facing plant material engagement surface of the second plant engagement means.

As will be appreciated form the forgoing, the plant material breaking surface assumes some importance in the overall operation of the apparatus. In one embodiment, the plant material breaking surface is shaped so as to form a bend of at least about 90 degrees in the respective second lower portion of the plant stem. Forming a bend in the plant stem provides a putative point of region where the stem is more likely to break in the face of increasing tension. It is not necessary for the bend to a particularly sharp (such as would be the case where the breaking surface forms a corner), however it will typically be formed by a cylinder or a segment of a cylinder of sufficiently small diameter so as to concentrate tension in a region or a point along the plant stem. Where the plant breaking surface is formed by a cylinder, the diameter of the cylinder must be sufficiently small so as to provide the necessary tight radius in the bend of the stem so as forming a putative breaking point or region. In any event, some routine experimentation may be required to decide a preferred configuration for breaking surface, having regard to the mechanical properties of the stem to be broken.

When entrapping plant material between the respective plant material engagement surfaces of the first and second engagement means, the plant material should be securely entrapped so far as possible to avoid any slippage. It must be recalled that breakage of the plant stem is reliant on the development of sufficient tension in the stem, and slippage would clearly limit the level of tension achievable. In that regard, at least one of the plant engagement surfaces should generally capable of sound frictional engagement with the plant material. The other engagement surface may not be so configured, and may function more so to compress the plant material against the frictionally engaging surface.

As will be appreciated, frictional engagement is improved where a greater engagement surface area is provided. In that regard, a plant material engagement surface may be deformable (and even possibly resiliently deformable) so as to deform about the plant material, and possibly also deform about a profile of the other plant material engagement surface.

Typically, the plant material engagement means are maintained in spaced relation such that the plant material engagement surface of the first plant material engagement means is capable of deforming a deformable surface of the second plant material engagement means. The spatial relatedness may be provided by the spatial relatedness of the respective rotational axes of the first and second plant engagement means. In addition or alternatively, the first and second plant material engagement means may be dimensioned, shaped or otherwise configured to allow one plant engagement surface to contact and deform the other plant engagement surface.

In many circumstances, the apparatus will be configured to allow the plant material engagement surface of one plant material engagement means to alternately deform and release the deformable surface of the other plant material engagement means in a repeating cycle. Upon release, the deformable surface resilient will assume a non-deformed state where it is sufficiently resilient, ready for a further cycle of entrapping and releasing plant material as the harvesting apparatus is move forward into new plant material.

The skilled person having benefit of the present invention will be capable of conceiving of a range of means by which an engagement surface may be configured to be deformably resilient. For example, the surface may be, or may be supported by, an elastic material such as a rubber, a foam, or a synthetic polymer. In one embodiment, the surface is provided by way of a resilient material suspended between two points, so as to deformable in a central region. The resilient material will typically have a textured or tacky upper face so as to provide for frictional engagement of incoming plant material.

In contrast to the plant engagement surface described above, the plant breaking surface will typically be non-deformable. Any deformability in the breaking surface would likely absorb some of the tensile forces to which the overlying plant stem is exposed, thereby lowering to probability that the stem will break in good time, or break at all. Accordingly the plant breaking surface may be fabricated from, or may be supported by, a metal, a rigid plastic or wood for example.

In some embodiments of the apparatus, the second plant material engaging means may provide a further surface configured to contact the plant stem at a third respective portion of the plant stem that is lower than the second portion of the plant stem. This contact surface typically rotates into place when a portion of the plant stem is already laid onto the breaking surface. The function of the contact surface is to assist in ensuring the increasing tension in the portion of the plant stem on the breaking surface is maintained. Thus, the contact surface acts to maintain the bend in the plant stem at a desired angle. For example, the contact surface may act to maintain the bend at an angle of 90 degrees or greater.

As will be appreciated from the foregoing, the breaking surface and the contact surface may be disposed on the second plant material engagement means, and in that regard will therefore typically be moveable along the same arc where disposed the same distance from the axis of rotation.

Although not essential to the invention, the first and second plant engagement means may be circular, and have no eccentricity. Conveniently the first and/or second plant engagement means may be a rotor having a number of arms extending radially from a central hub the terminus of an arm will generally support a surface for contacting or engaging with plant material. It will be understood that the term “support” includes the circumstance whereby the rotor arm terminus itself provides the surface. Expressed differently, there is no necessity for the engagement or contact surface to be separately formed to the rotor arm terminus.

A rotor may comprise any useful number of arms, such as 3, 4, 5, 6, 7, 8 or more. In some circumstances, both first and second plant engagement means are rotors and are synchronized such that the arms of one rotor enter the spaces between arms of the other rotor during rotation.

In many circumstances, the first rotor has a greater diameter than the first rotor. The increased diameter is to provide for greater spaces between the arms, the greater spaces facilitating capture of incoming plant material. One function of the first rotor is to bend the upper region of a plant stem downwardly onto the plant material engagement surface of the second rotor. The terminus of the arm must be sufficiently distant from the rotor hub to contact the stem at the required distance from the terminus of the plant (in the case of tea, just inferior to the desirable bud and two leaves structure). Without that distance and space, the desired terminal region of the plant may not be captured and entrapped, or if captured may be deformed leaving to entrapment at an undesired level of the stem.

Once the plant stem is broken over the breaker surface, the freed terminal region of the plant continues to be pulled through the apparatus (by way of continued engagement with the first and second plant engagement means). Typically, the freed plant material is released from the first and second plant engagement means on the side of the apparatus generally opposite to that in which it entered. In any event, some means may be required to carry away freed plant material into a collection receptacle of some type. Such carriage may be achieved by any number of means such as a vacuum source to suck the material toward a collection receptacle of an air pressure source to blow the material toward a collection vessel. In other embodiments some mechanical means is used to contact the freed plant material and push it toward a collection receptacle.

In one embodiment, a rotating brush or a rotor is disposed immediately adjacent to the first and second plant material engagement means so as to be able to contact free plant material being expelled therefrom. A rotor having arms each presenting a broad face is useful in so far as the broad faces act not only to push material away from the first and second plant material engagement means, but also as fan blades or vanes which function to establish an air current away from the engagement means. The air current assists in propelling the freed plant matter well clear of the first and second plant material engagement means thereby lessening the probability of clogging in the apparatus.

The present invention will now be more fully described by reference to the non-limiting examples provided in the accompanying drawings

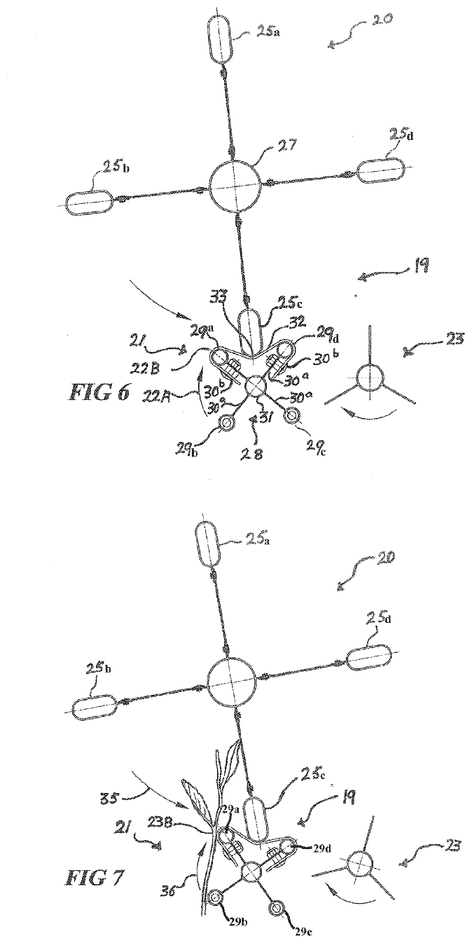

Reference is made to the apparatus of FIG. 6 capable of mechanically selectively hand plucking two leaves and a bud. The apparatus is shown devoid of any plant material for clarity. The apparatus operates by means of the selective plucking assembly (19) comprised of capture rotor (20), plucking rotor assembly (21) and rotor vane plucked leaf thrower (23).

The capture rotor (20) is comprised of rotor tubes (25) and drive tube (27) each disposed at the end of a rotor arm. The capture rotor (20) is interconnected and jointly driven at a ratio in one preferred embodiment of 4:1 to provide continuous accurate timed engagement with the capture rotor (20) and the plucking rotor (21).

The capture rotor (20) is driven and timed to rotate in reverse direction to the plucking rotor (21) and at a ratio of four rotations of the plucking rotor (21) to one rotation of the capture rotor (20). By this means the arc of the rotor tubes (25) engages precisely central to the plucking rotor members (29) and the resilient member (32). This arrangement provides a long deep engagement over a prolonged period of time to ensure selective mechanical hand plucking across all parts of the tea bush frame including the variation of restraint from the near horizontal softly supported side branches of all sides of a tea bush frame as against the central vertical branches which two leaves and a bud would only mainly be plucked with brief nip type plucking means.

The capture rotor (20) is comprised in one embodiment of an aluminium extrusion (28) comprised of outer tubes (29) support fins (30) and central drive tube (31). The capture and force of the retention rotor (21) is provided by the resilient member (32) being a sheet-like member in this embodiment which is fixed to the plucking rotor by fasteners (30a) and (30b).

In the embodiment of FIG. 6, the capture rotor (20) may be considered a first plant engaging means, and the outer face of each rotor tube being a moveable plant engagement surface. In this case, the plant engagement surface is movable along an arc. Particularly, the arc in this embodiment forms a circle or a segment of a circle.

In the embodiment of FIG. 6, the plucking rotor (19) may be considered a second plant engaging means, and the upwardly directed face of the resilient member (32) being a considered a moveable plant engagement surface. In this case, the resilient member (32) is movable along an arc. Particularly, the arc in this embodiment forms a circle or a segment of a circle.

The rotor tubes (25) are substantially rigid, while the resilient member (32) is deformable, and particularly elastically deformable such that a rotor tube (25) rotating onto the resilient member (32) deforms the resilient member (32) so as to bow into a shallow U-shape as shown in FIG. 6. In use, any plant material entrapped between the rotor tube (25c) and resilient member (32) is substantially protected from damage given the deformability of the resilient member (32). As will be appreciated, where both rotor tube (25c) and resilient member (32) were rigid, the entrapped plant material would be crushed and possibly even severed. As explained further infra, the desired bud and two leaves of the tea plant is entrapped in region between the rotor tube (25c) and resilient member (32). Any damage in the plant could lead to breakage in the clamped region (especially given that the plant stem is placed under tension as plant material is drawn into the apparatus) meaning that the plant is severed at a level higher than desired and therefore desired plant structures may be left on the plant under harvest.

The surface over the rotor tube (29a) may be considered a breaker surface. As will be noted this surface is formed by the overlying resilient member (32). Support from the rotor tube (29a) results in the resilient member being non-deformable as so able to provide a substantially unyielding surface over which a plant stem may be tensioned, and ultimately broken.

Staying with FIG. 6 the surface of rotor tube (29a) may be considered a plant contacting surface configured to facilitate plant material being maintained on and tensioned across the breaker surface (which in this embodiment is the surface the resilient member (32) which overlies the rotor tube (29a).

The rotor vane plucked leaf thrower (23) may be considered a plant material carriage means of the apparatus. In the embodiment of FIG. 6 the vanes of the rotor vane plucked leaf thrower (23) act to contact harvested plant material and urge the material away from the rotors (19) and (20).

In use, the apparatus of FIG. 6 is moved from right-to-left (as drawn) over the plants under harvest. The capture rotor (20) and plucking rotor (21) rotate axially in opposite direction such that plant material is drawn into the apparatus from the left by entrapment between the rotors (20) and (21), the terminus of the plant being severed by tensioning over the breaker surface of rotor (21) and the harvested terminus of the plant (which is now freed) being expelled about the left side of the vaned rotor (23) which acts to propel the harvested material to the right.

The capture rotor (20) is mechanically interconnected with and jointly driven at a suitable ratio (in one embodiment of 4:1) to provide continuous accurate timed engagement with the capture rotor (20) and the plucking rotor (21).

Further disclosure as to the operation of the embodiment shown in FIG. 6 will now be provided by reference to the embodiment of FIG. 6 actually engaging plant material, as detailed in FIGS. 7 to 11.

Turning firstly to FIG. 7 there is shown an upwardly extending terminus of a plant having a first upper portion (comprising the two leaves, bud, and stem portion immediately below the lowest leaf) and a second lower portion (comprising the part of the stem contacting the breaker surface of tube (29b)), and stem portions immediately above and below). As will be recalled, the apparatus is moving right-to-left (as drawn) with the rotor (20) being rotated counterclockwise and the rotors (21) and (23) being rotated clockwise. At this point, no plant material has been entrapped, moved or broken.

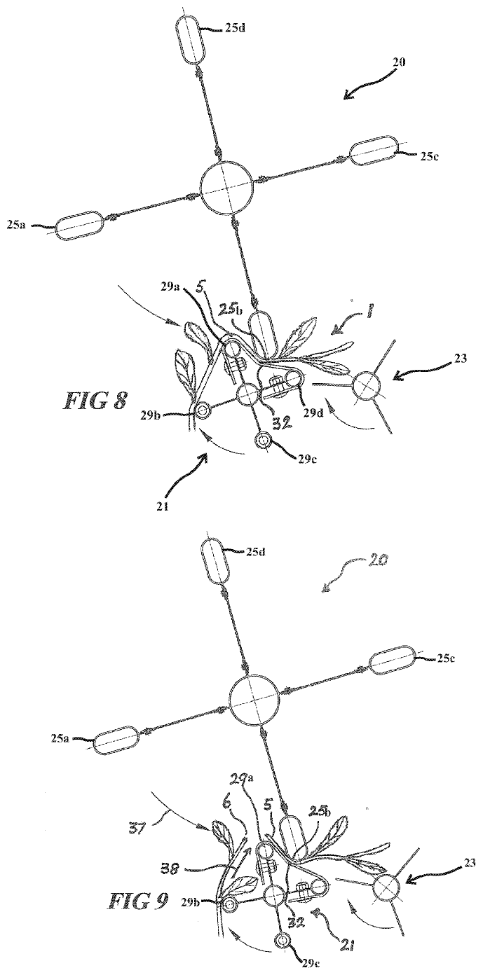

At FIG. 8, the rotor tube (25b) is shown having been rotated downwardly so as to contact the plant first upper portion comprising the two leaves and bud (1) and compress it against the resilient member (32), causing the plant material to become entrapped. The resilient member (32) is deformed by the rotor tube (25) to assume the shallow U-shape shown.

Frictional engagement between the plant material and the resilient member (32) and/or the surface of the rotor tube (25b) coupled with the rotation of rotors (20) and (21) moves the entrapped plant left-to-right (as drawn).

The breaker surface over the rotor tube (29a) has rotated upwardly so as to support the plant stem about the region of mutual contact. The plant material contact surface provided by the rotor tube (29a) assists in maintaining the shallow U-shape of the plant stem formed across the breaker surface over the rotor tube (29a). It must be appreciated that the lower end of the plant material is eventually anchored into the ground (via connection to lower plant structures, not drawn) and so the continued rotation of rotors (20) and (21) cause a stretching and tension on the plant stem. The tensile forces are effective mainly in the region of the stem curved about and supported by the rotor tube (29a) and eventually lead to breakage of the stem in that region, as shown in FIG. 9.

FIG. 9 shows the severed plant material (comprising the desired shoot and two leaves) remaining compressed between the rotor tube (25b) and resilient member (32), and still being moved left-to-right by the rotation of rotors (20) and (21).

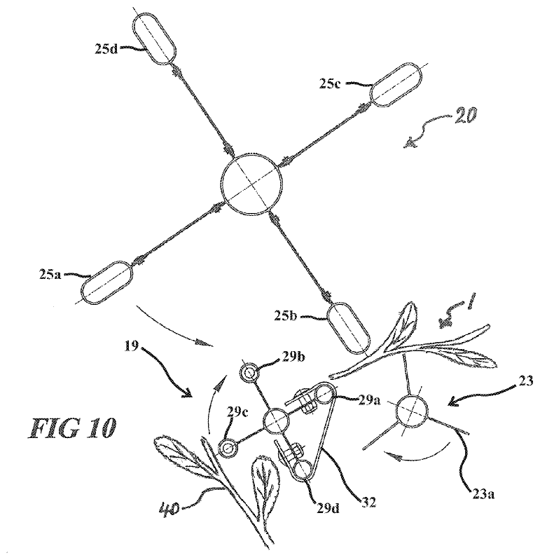

As shown in FIG. 10, the severed plant material (1) is ultimately freed from entrapment as the rotor tube (25b) and resilient member (32) rotate upwards and downwards respectively, and away from each other. It shall be noted that the resilient member (32) has returned to its non-deformed (linear) state since losing contact with the rotor tube (25b).

The severed plant material (1) is propelled generally left-to-right and toward a collection area (not shown) by the rotor (23) with some possible assistance by the movement of the adjacent rotor tube (29b). The rotor (23) may provide mechanical assistance by contacting the plant material (1). In addition or alternatively, the rotor (having vanes, one marked (23a)) may generate an air current so as to urge the plant material (1) toward the collection area.

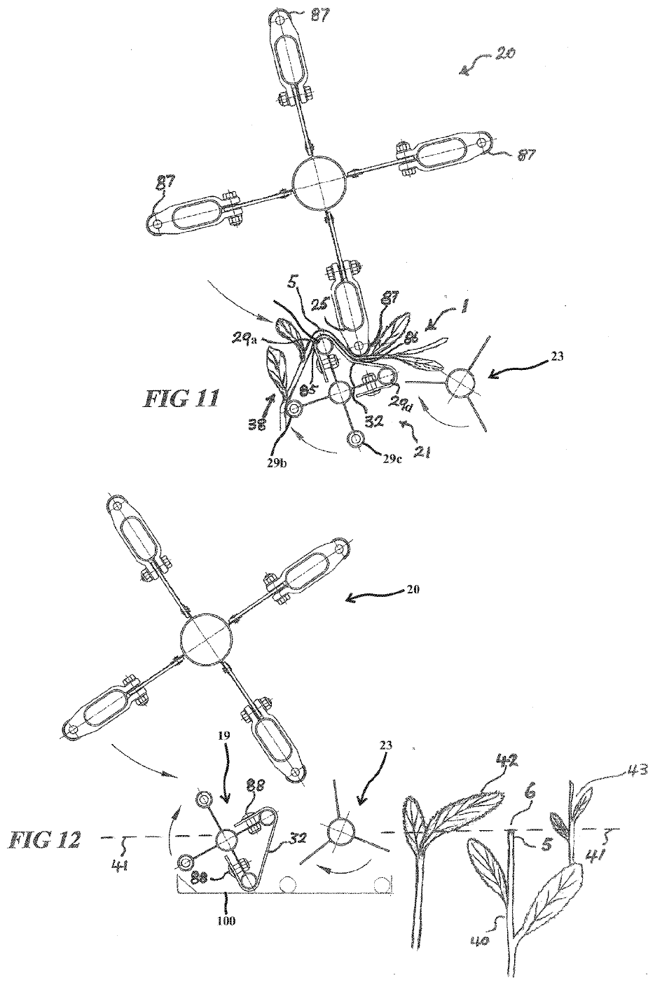

As the apparatus is moved forward (right-to-left) the unharvested plant material (40) comprising stem and undesirable lower leaves is deflected downwardly and to the left. This deflection is cause by contact with the underside of a housing or a guard (not drawn in this Figure, but drawn in FIG. 12 and marked (100).

It will be noted from FIG. 10 that only the stem of the unharvested plant material (40) is snapped and broken cleanly (as it must be for the harvested material to be freed) however no other structures are damaged. For example, the two remaining leaves of plant material (40) may be maintenance foliage and are preferably left in an undamaged state. Given the ability of the apparatus to selectively harvest, any side branches and juvenile shoots would be similarly undamaged. Thus, the plant as a whole is better able to function so as to encourage new growth for the next harvest by way of the undamaged juvenile shoots rapidly maturing to form two leaves and a bud.

FIG. 11 shows the unique frictional engagement of the plant material against the resilient member (32) from position (85) to position (86). The resilient member (32) is held stationary in a fixed relationship to the respective plucking rotor members (29) providing a small diameter and causing the stem (5) to be entrapped and sharply bent so that when the plucking rotor force is applied in the direction of arrow (38) the stem (5) will immediately snap.

The plucking action as shown in FIG. 11 with the interaction providing the same mechanical hand plucking action for selective only two leaves and a bud and leaving maintenance foliage and juvenile buds identical to selective hand plucking used by the human race for millennia.

Advantageously, the present apparatus is capable of selectively plucking at a rate of 92,000 times per hour across the full width of the tea bush canopy. This unique invention allows for the leaf capture rotor tubes (25) to engage directly and deform the resilient member (32) for selective plucking or as shown in FIG. 11 another embodiment includes brackets with continuous contact lengths of rollers (87) engaging with plant material by clamping against the resilient member (32).

FIG. 12 shows that when plucking at the level shown as a dotted line at (41) the maintenance foliage (42) and juvenile immature shoots (43) are not damaged and are not plucked. The mature two leaves and a bud (40) stem (5) is snapped at (6) and the selected two leaves and a bud is plucked at (6) as shown in FIG. 9 leaving the immature juvenile shoot (43) of FIG. 12 to grow on to two leaves and a bud for the next short round in 7 to 8 days increasing yields and maintaining high yields and high quality. FIG. 12 further shows quick attachment of the resilient member (32) by means of press over attachment button heads (88).

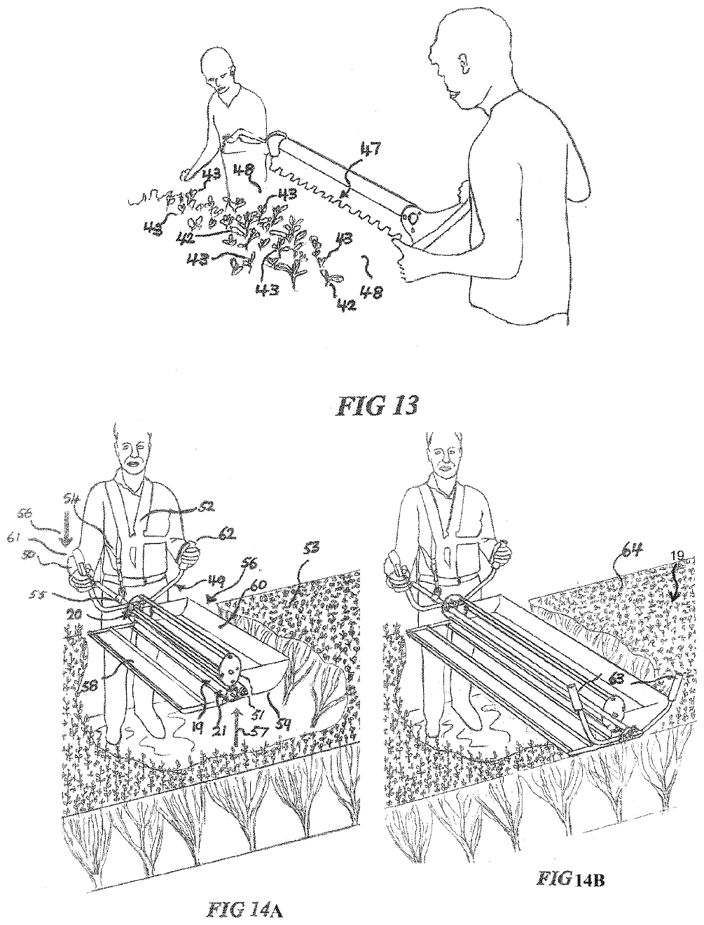

For comparative purposes only, FIG. 13 shows a prior art contrivance used internationally for mechanically harvesting tea by reciprocating cut all hedge trimmer type non-selective means (47). The blades are adapted to cut plant material at one level only, and accordingly the juvenile next generation shoots (43) are all severed thereby greatly reducing crop yield and crop quality. Detrimentally, this prior art contrivance harvests hard maintenance foliage (42) which has the effect of substantially reducing the quality and value of manufactured made tea using this material.

An advantage of the present apparatus (a least in some embodiments) is that it provides for mechanical selective plucking that mimics the action of a human plucker to harvest intact two leaves and a bud (1) as shown in FIG. 10, and to not pluck hard dark green maintenance foliage (42), nor pluck juvenile next generation shoots (43) as shown in FIG. 12.

FIG. 14A shows an embodiment of the present apparatus (19) having a capture rotor (20) and a plucking rotor (21) (as disclosed in FIG. 6.) fitted to a light-weight tubular frame (49). In this embodiment, rotation of the rotors (20) and (21) is achieved by an engine (50) connected via a centrifugal clutch to a drive tube and shaft (51). The frame (49) provides a support structure and transmission drive.

An adjustable shoulder harness (52) may be used to adjust the operating height of the machine to suit the tea canopy (53). The adjustment (54) may provide vertical height variation at the attachment point (55), and provide a pivot point to balance the weight of the engine (50) acting in the direction of arrow (56). This force acts through the restrained pivot point (55) to provide an upward force on the entire harvesting machine (56) in the direction of arrow (57). A canard (58) provides support and guidance for level operation of the machine. The floor (59) of the leaf collection bin (60) provides further support and guidance at the rear of the machine. The collection bin (60) is emptied by simply rotating the handles (61) and (62) in a counter-clockwise direction allowing rotation of the frame (49) through support pivot (55). The canard (58) and floor (59) provide a means of using the machine on very steep slopes of continuous tea by means of a winch and light weight winch cable attached to the machine.

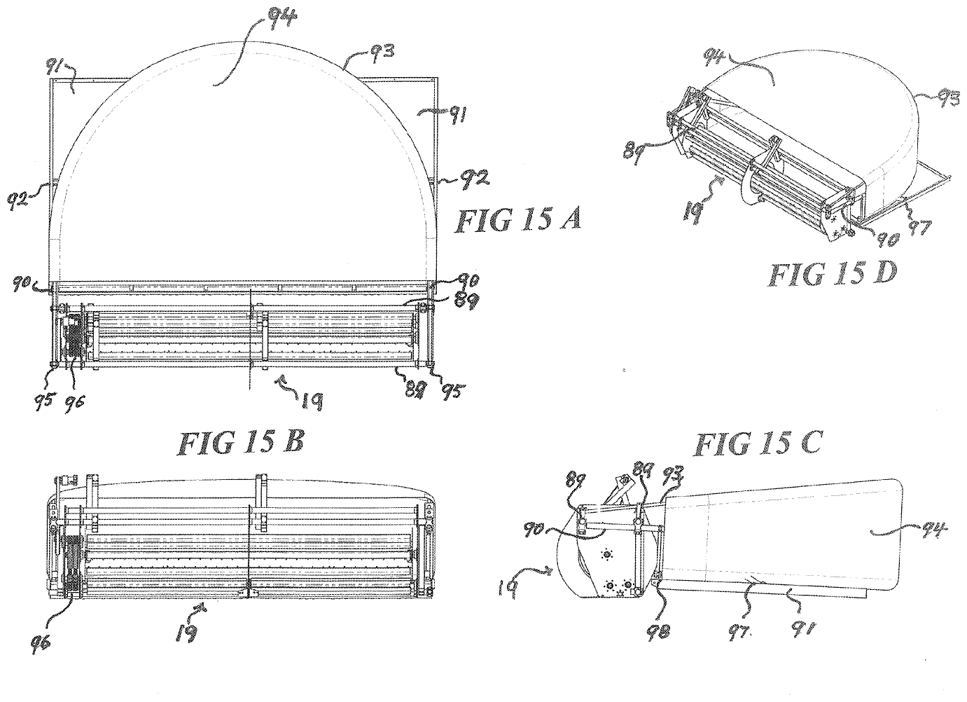

FIG. 14B shows a simplified drawing of the apparatus (19) shown in FIG. 15 to display clearly the second pair of handles (63) to be held by a second operator.

FIG. 15A shows a plan view of an embodiment being a two-man 1500mm plucking width mechanical plucker assembly (19) fitted to two light weight high tensile aluminium or carbon fibre tubes (89) which are attached to rear support tubes (90) which is centrally attached to a skid pan at (92). A fibre glass rod (93) is held under tension to form a curved light weight strong plucked leaf storage bag (94). The skid pan (91) supports the assembly (19) and the plucked leaf in the lightweight collection bag (94). The plucking height and the front of the plucking assembly (19) in one embodiment is supported by adjustable height connection to two shoulder harness (not shown) at (95).

FIG. 15B is a front view showing the lightweight transmission of dual drive double sided timing belts for reverse rotation drive high ratio speed reduction and timing at (96).

FIG. 15C shows an end elevation of the plucking assembly (19) showing the support tubes (89) attached to the skid pan (91) at (97) and (98) with a fibre glass rod supporting the plucked leaf storage bag (94).

FIG. 15D is a three-dimensional view of the plucking assembly (19).

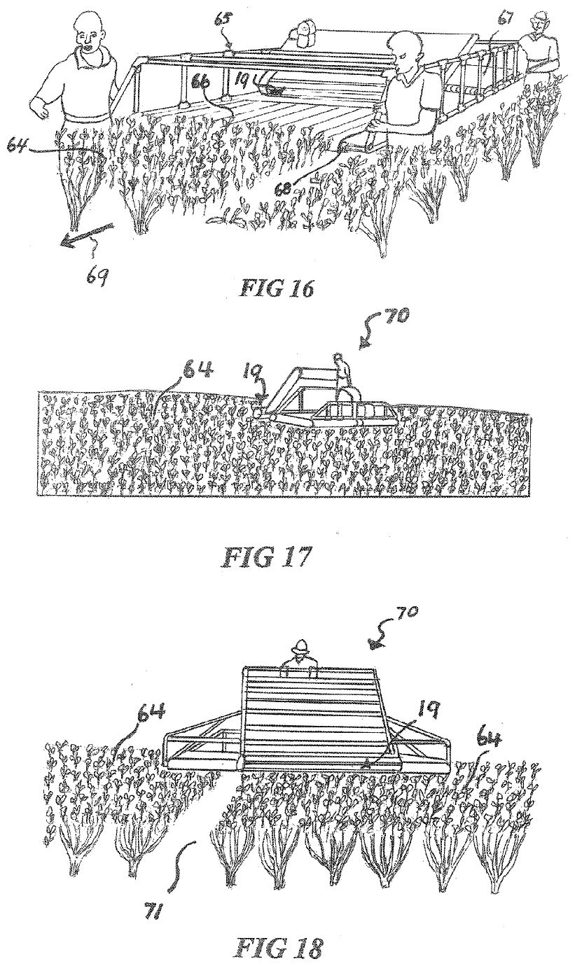

FIG. 16 shows a further embodiment of the present apparatus being a tea plucker assembly (19) attached to a light-weight frame (65) supported solely by the belts (66) and (67) supported entirely by the tea canopy (64). The assembly (19) and light weight frame (65) are driven forward together by the roller (68) rotating and driving forward in the direction of arrow (69).

FIGS. 17 and 18 show a further embodiment of the present apparatus being a tea plucker assembly (19) attached to a ride-on, self-propelled machine which is solely supported by the tea canopy (64) and having no contact with the ground (71).

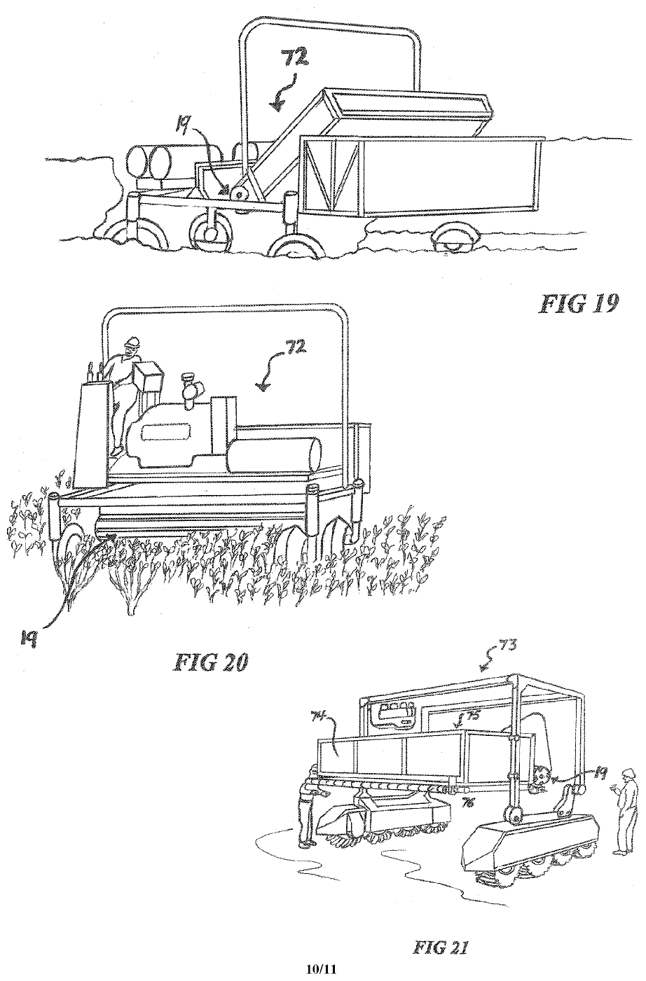

FIGS. 19 and 20 show another embodiment of the present apparatus being a plucker assembly (19) attached to a self-propelled ride-on four-wheel drive platform having a four-wheel steering machine (72).

FIG. 21 shows another embodiment of the present apparatus being a plucker assembly (19); attached to a ride-on, self-propelled multi-wheeled machine (73) with the capacity to span and selectively harvest three rows of tea bushes of a continuous tea canopy with a large leaf storage bin (74) provides quick leaf discharge by means of hinged rear door (75) and movable conveyor floor (76).

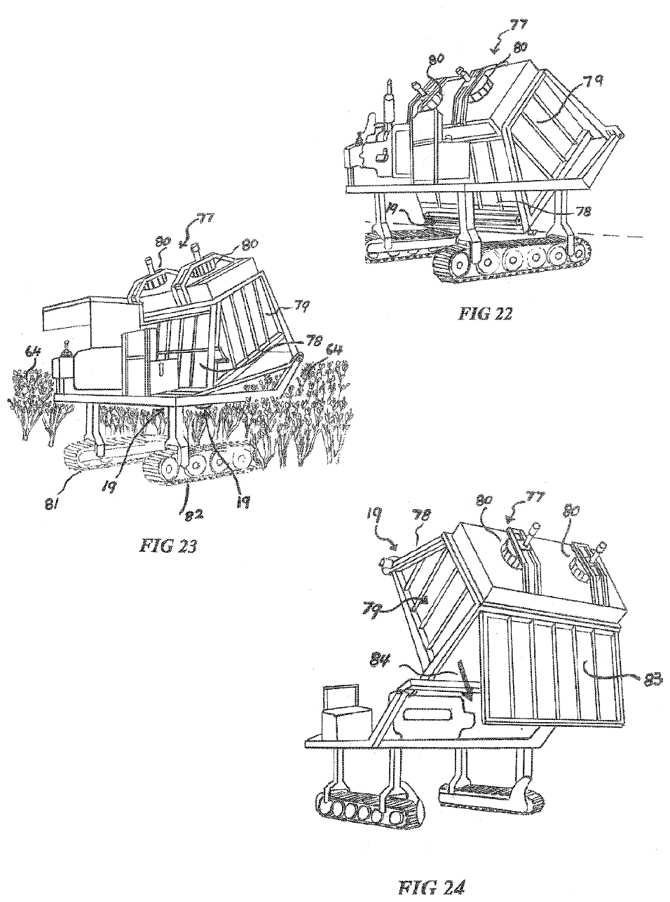

FIG. 22 shows another preferred embodiment of the present apparatus being a plucker assembly (19) attached to a very high capacity, high performance self-propelled tracked machine (77) the selectively plucked leaf being transferred via vacuum duct (78) through to an eight cubic metre collection chamber (79) by means of backward curved turbines (80).

FIG. 23 shows the tracks (81) and (82) providing a low-profile ground support which passes between tea bush hedge rows and below the tea canopy. This arrangement allows harvesting of a continuous tea canopy (64) for increased yields and to eliminate weed growth that would otherwise grow in open tracks.

FIG. 24 shows the leaf bin (79) in the very fast load discharge position whereby the rear door (83) swings open from the collection position normally held shut by gravity and vacuum only. The selected bulk leaf of eight cubic metres immediately discharges in the direction of arrow (84).

While the present invention has been described by reference chiefly to the harvesting of the desired bud and two leaves structure of a tea plant, the invention is also clearly application to the harvesting of other structures of a tea plant. Indeed, the invention may be applied to another crop plant apart from tea. Given the benefit of the present specification, the skilled person is enabled to make any necessary modification to the described and exemplified embodiments of the invention necessary so as to workable in any application to a crop plant and for the harvesting of a desired crop plant structure.

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Accordingly, the spirit and scope of the present invention is not to be limited by the foregoing examples, but is to be understood in the broadest sense allowable by law.

1. An apparatus for selectively harvesting a plant material comprising a stem, the apparatus comprising:
a first plant material engaging portion being rotatable about a first axis,
a second plant material engaging portion being rotatable about a second axis in the opposite direction to, and synchronized at a fixed ratio with, the rotation of the first plant material engaging portion,
the first and second plant material engaging portions each having a moveable plant material engagement surface configured to entrap a first respective upper portion of a plant stem therebetween and with continued rotation of the first and second plant material engaging portions pull the entrapped first respective upper portion of the plant over a time period so as cause increasing tension in a second respective lower portion of the plant stem,
the second plant material engaging portion comprising a plant material breaking surface which is moveable along an arc so as to contact the second respective lower portion of the plant stem,
wherein the plant material breaking surface is shaped so as to form a bend in the second respective lower portion of the plant stem as it is moved along the arc, and with the increasing tension in the second respective lower portion of the plant stem cause breakage of the second respective lower portion of the plant stem over the plant material breaking surface.

2. The apparatus of claim 1, wherein the synchronization at a fixed ratio provides that for each single rotation of the first plant material engaging portion, the second plant material engaging portion rotates at least 2 more times.

3. The apparatus of claim 1, wherein the first axis is above the second axis.

4. The apparatus of claim 1, wherein the first axis is offset from a vertical axis extending through the second axis.

5. The apparatus of claim 4, wherein the offset is toward the side of the apparatus from which plant material is drawn.

6. The apparatus of claim 1, wherein the plant material breaking surface is shaped so as to form a bend of at least about 90 degrees in the respective second lower portion of the plant stem.

7. The apparatus of claim 1, wherein the plant material breaking surface comprises a curve or a corner configured to form a bend in the respective lower portion of the plant stem.

8. The apparatus of claim 1, wherein the plant material engagement surface of the second plant material engaging portion is deformable.

9. The apparatus of claim 8, wherein the first and second plant material engaging portions are maintained in spaced relation such that the plant material engagement surface of the first plant material engaging portion is capable of deforming the deformable surface of the second plant material engaging portion.

10. The apparatus of claim 8, configured such that the plant material engagement surface of the first plant material engaging portion is capable of alternately deforming and releasing the deformable surface of the second plant material engaging portion.

11. The apparatus of claim 8, wherein the plant material engagement surface of the second plant material engaging portion is resilient such that upon release the plant material engagement surface assumes a non-deformed state.

12. The apparatus of claim 8, wherein the plant material engagement surface of the second plant engaging portion is a resilient belt suspended between two fixed belt mounts so as to be deformable in the region between the two fixed belt mounts.

13. The apparatus of claim 1, wherein the plant material breaking surface is non-deformable or of limited deformability so as to facilitate breakage of plant material there over.

14. The apparatus of claim 1, wherein the second plant material engaging portion comprises a plant material contacting surface moveable along an arc and configured to contact the plant stem at a third respective portion of the plant stem that is lower than the second portion of the plant stem, wherein the plant material contacting surface is configured to assist in effecting the increasing tension in the respective second lower portion of the plant stem.

15. The apparatus of claim 14, wherein the arc along which the plant material contacting surface is moveable is the same arc as the arc along which the plant material breaker surface is moveable.

16. The apparatus of claim 1, wherein the second plant engaging portion comprises a rotor having at least sequential first, second and third arms.

17. The apparatus of claim 16, wherein where the plant material engagement surface of the second plant engaging portion comprises a resilient belt, the resilient belt is suspended between sequential first and second arms and the sequential third arm supports the plant material contacting surface.

18. The apparatus of claim 16, wherein the breaking surface is supported by the respective second arm.

19. The apparatus of claim 16, wherein the first and third sequential arms are disposed along a first axis.

20. The apparatus of claim 19, wherein the second sequential arm is disposed along a second axis that is substantially orthogonal to the first axis.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
